(19) United States
(12) Patent Application Publication
(10) Pub. No.: US 2026/0246494 A1
(43) Pub. Date: Aug. 20, 2026

(54) SYSTEM AND METHOD OF ANTENNA CALIBRATION FOR AN NFC TAG

(71) Applicant: STMicroelectronics (China) Investment Co., Ltd., Shanghai (CN)

(72) Inventors: Tianhao XIONG, Shanghai (CN); Gang WU, Shanghai (CN)

(73) Assignee: STMicroelectronics (China) Investment Co., Ltd., Shanghai (CN)

(21) Appl. No.: 19/156,846

(22) PCT Filed: Feb. 27, 2023
(86) PCT No.: PCT/CN2023/078552

§ 371 Date: Aug. 14, 2025

(51) Int. Cl. H04B 5/43; H04B 5/79

(52) U.S. Cl. CPC H04B 5/43; H04B 5/79

(57) ABSTRACT

The present disclosure is directed to a near field communication (NFC) tag including tunable electrical components for dynamically tuning the NFC tag after manufacturing and during the operation. The disclosed NFC tag includes a tunable capacitor coupled to an antenna. A capacitance value of the tunable capacitor adjusts an output impedance of the NFC tag.

### BACKGROUND

### Technical Field

The present disclosure is directed to antenna calibration of a near field communication (NFC) tag in an NFC system.

### Description of the Related Art

In general, near field communication (NFC) systems include a wireless communication link between two or more devices positioned in a limited distance from each other. Typically, a communication distance between the NFC devices is less than 20 centimeters (cm) or less than 10 cm, based on the device characteristics. For instance, the NFC devices may be part of an active NFC system, i.e., tags include a power source that can work at longer distances as compared with a passive NFC system. In the passive NFC system, one or more devices, such as a tag, may be passive, without any power source. Although the passive NFC system is limited to a shorter distance, it is more energy and cost efficient as compared with the active NFC system. In the passive NFC system, an active device (e.g., NFC reader or initiator) may wirelessly provide a sufficient energy for the passive devices (e.g., NFC tag or listening device). In such a condition, the passive devices are operating in an energy harvesting mode, where the passive devices are activated by receiving a wireless signal from the active device.

Typically, the communication between the NFC reader and the NFC tag is through one or more antennas wirelessly coupled together. The antenna in each of the NFC reader and NFC tag forms a resonance circuit that is equivalent to an inductor-capacitor (LC) resonance tank. A resonance frequency of the antenna is designed by adjusting the equivalent LC resonance tank in a desired frequency, such as 13.56 MHz as a standard frequency band for NFC systems. However, the resonance frequency of the antenna may be changed after the production and during the operation (known as detuning). Several conditions may result in detuning the resonance frequency of the antenna, such as variation of the circuit components (e.g., capacitance and inductance of the circuits coupled to the antenna), manufacturing parameter of an end product (e.g., variation of conductive material properties during assembly of the tag), changing of environmental condition (e.g., temperature and humidity), and external field effect (e.g., placing a magnetic or electric component near the NFC tag or NFC reader). This changing of the resonance frequency is compensated by a tuning process of the antenna after manufacturing. The tuning process may be repeated in response to changing environmental conditions or after a period of time. The tuning process may include adjusting the capacitance and inductance of circuits inside the NFC tag and reader.

A communication link between the NFC reader and the NFC tag is designed to work in a resonance frequency. Hence, the antenna and circuit of the NFC tag is designed to have most efficient responses at this resonance frequency. The most efficient responses are related to an impedance matching of the antenna and the circuit of the NFC tag at the resonance frequency. The impedance matching refers to adjusting capacitive or inductive loads of a resonance circuit (e.g., an LC tank as an equivalent resonance circuit of the antenna) in accordance to reducing imaginary parts of the output impedance of the resonance circuit at the resonance frequency. In NFC systems, the impedance matching of the antenna also known as tuning the NFC tag at the resonance frequency. The tuning may be performed after manufacturing due to deviation of the impedance values of the electrical components in the NFC tag, as well as changing of environmental conditions and presence of external magnetic or electric fields.

### BRIEF SUMMARY

The present disclosure is broadly directed to a near field communication (NFC) system including an active NFC reader that is configured to interact with one or more passive or semi-passive NFC tags. Each of the NFC tags includes an antenna for communicating with the NFC reader and a circuit coupled to the antenna, which controls the operation of the NFC tag. The circuit may include a controller having a memory. The NFC tag receives signals from the NFC reader by the antenna. The controller analyzes the received signal and may generate and transmit a response signal to the NFC reader by the antenna. The received signal may include commands to manage the operation of the NFC tag.

In particular, an NFC tag is disclosed, which includes tunable electrical components for dynamically tuning the NFC tag after manufacturing and during operation or use. The NFC tag includes a circuit coupled to an antenna. The antenna is equivalent to a resonance circuit, such as an inductor-capacitor (LC) tank. A tunable (adjustable or variable) capacitor is coupled to the antenna. A capacitance value of the tunable capacitor is combined with the equivalent resonance circuit of the antenna to form an output impedance of the NFC tag. Thus, changing of the tunable capacitor changes the output impedance of the NFC tag. The output impedance is a parameter that defines the resonance frequency of the equivalent resonance circuit of the antenna. Accordingly, changing of the tunable capacitor results in tuning of the NFC tag.

In various embodiments of the present disclosure, the NFC tag is activated by receiving a signal from the NFC reader. By activating the NFC tag, a controller of the NFC tag sets a default capacitance to the tunable capacitor. When the NFC tag receives a calibration command from the NFC reader, the controller of the NFC tag changes the capacitance value of the tunable capacitor to a new capacitance. In addition, the controller measures the strength of the received signal by the NFC tag corresponding to each of the default and new capacitances. The controller compares the measured strength of the received signals and sets the new capacitance as the default capacitance of the tunable capacitor in response to the strength corresponding to the new capacitance being greater than the strength corresponding to the default capacitance. Otherwise, the controller maintains the default capacitance to the tunable capacitor.

The controller may repeat this process including the change of the tunable capacitor to a plurality of capacitances and comparing the strength of the received signals corresponding to each of the plurality of the capacitances to find a maximum strength between a plurality of measured strengths. Thus, a final capacitance value corresponding to the maximum strength is set to the tunable capacitor as the default capacitance. The final capacitance value tunes the NFC tag, which consequently causes receiving the maximum strength of the signals at the resonance frequency. This process results in tuning the antenna of the NFC tag in response to receiving the calibration command. This tuning process can be repeated for each NFC tag after manufacturing and during the lifetime, while the output impedance of the NFC tag may be changed during operation by passing a period of time and changing of the environmental conditions. Advantageously, this type of the tuning is not based on the changes of hardware designs of the NFC tags and is dynamically controllable by the controller of the NFC tag.

In some embodiments, the tunable capacitor includes a plurality of capacitors coupled to the antenna. Each of the plurality of capacitors includes a switch. The controller may change an equivalent capacitance of the tunable capacitor by switching ON or OFF a subset of the plurality of the capacitors. In addition, the controller may store the strength of the received signal corresponding to each of the capacitance values in a memory. A maximum strength of the received signals and the corresponding capacitance value is determined from the stored values in the memory. At the end of the process of tuning, the controller may generate a calibration-done signal for transmitting to the NFC reader in response to the calibration command.

### BRIEF DESCRIPTION OF THE SEVERAL VIEWS OF THE DRAWINGS

Aspects of the present disclosure are best understood from the following detailed description when read with the accompanying figures. It is noted that various features are not necessarily drawn to scale.

FIG. 1 is a schematic circuit of an NFC tag in a vicinity of an NFC reader.

FIG. 2 is a flowchart of activating the NFC tag with the NFC reader of FIG. 1, in accordance with the present disclosure.

FIG. 3 is a flowchart of tuning the NFC tag in response to receiving a calibration command from the NFC reader based on an iterative process, in accordance with some embodiments.

FIG. 4 is a flowchart of tuning the NFC tag in response to receiving a calibration command from the NFC reader, in accordance with some embodiments.

FIG. 5 is a circuit of an implementation of the NFC tag of FIG. 1, in accordance with some embodiments.

### DETAILED DESCRIPTION

The present disclosure is directed to a near field communication (NFC) system including an NFC reader that is configured to interact with one or more passive or semi-passive NFC tags. Each of the NFC tags includes an antenna for communicating with the NFC reader and a circuit coupled to the antenna which controls the operation of the NFC tag. The circuit may include a processor having a memory. In particular, an NFC tag is disclosed herein which includes tunable electrical components for dynamically tuning the NFC tag after manufacturing and during operation or use. The circuit includes a tunable (adjustable or variable) capacitor coupled to the antenna. Changing of the tunable capacitor changes an output impedance of the NFC tag. The output impedance is a parameter that defines the resonance frequency of the NFC tag. Accordingly, changing of the tunable capacitor results in tuning of the NFC tag.

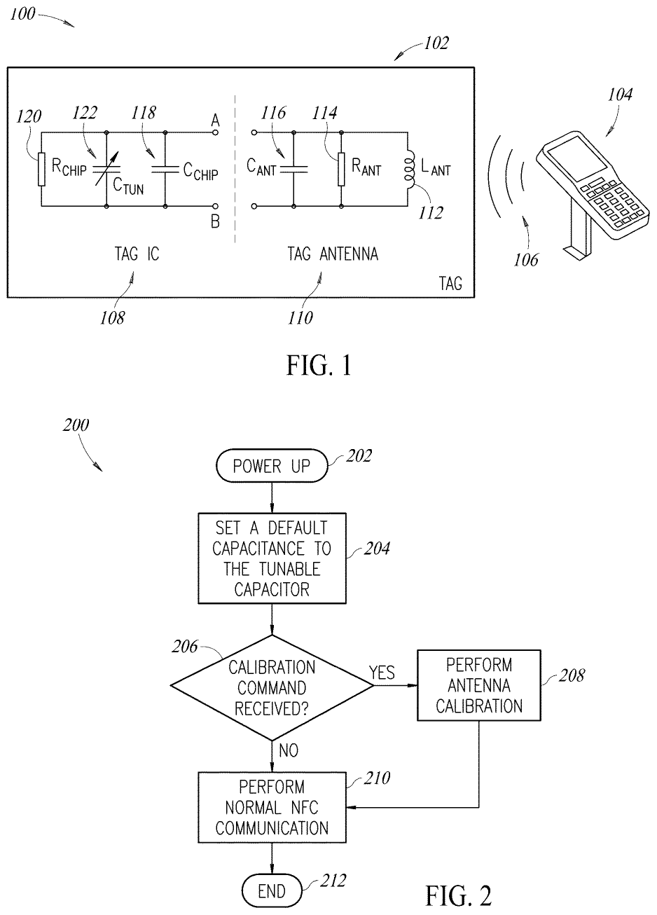

FIG. 1 is a schematic circuit of a near-field communication (NFC) system 100 including an NFC tag 102 in a vicinity or area of an NFC reader 104. The NFC tag 102 communicates with the NFC reader 104 through a wireless communication link 106. In various embodiments, the wireless communication link 106 exchanges data between the NFC tag 102 and the NFC reader 104 at a selected frequency, such as 13.56 MHz consistent with standard frequency bands for NFC systems. In addition, the NFC tag 102 may include contact interfaces (e.g., I2C, SPI, SWP, etc.) to exchange data with the NFC reader 104, for example during a calibration process.

The NFC tag 102 includes an integrated circuit (IC) 108 coupled to an antenna 110. In some embodiments, the IC 108 may include a processor (controller) and a memory (not shown here). The antenna 110 exchanges data with the NFC reader 104 by electromagnetic waves receiving from and transmitting to an antenna of the NFC reader 104. A distance between the antenna 110 and the antenna of the NFC reader 104 is a standard range of the NFC systems (e.g., less than 10 cm for passive NFC tags and less than 20 cm for active NFC tags). In various embodiments, the NFC tag 102 is a passive NFC tag which receives electrical power by rectifying the received electromagnetic waves from the antenna of the NFC reader 104. Alternatively, the NFC tag 102 is an active NFC tag which includes an internal power source. In addition, the NFC tag 102 may be a semi-passive NFC tag which includes a power supply pin to receive electrical power from an external source.

In this embodiment, the antenna 110 is modeled with an equivalent resonance circuit including a parallel RLC (resistor-inductor-capacitor) circuit. The parallel RLC circuit includes an inductor 112 (L_{ANT}), a resistor 114 (R_{ANT}), and a capacitor (C_{ANT}), that are coupled together in parallel. In some embodiments, other equivalent resonance circuit models (e.g., series RLC) rather than the parallel RLC circuit may be used for the analysis of the antenna 110. The antenna 110 is designed to operate at a resonance frequency that is an operation frequency of the NFC system 100. The operation frequency depends on the elements of the equivalent resonance circuit of the antenna 110. Thus, any changes of the inductor 112, the resistor 114, and the capacitor 116 may change the operation frequency. For instance, the changes of the operation frequency may happen due to variations of the elements of the equivalent resonance circuit (e.g., changing of material properties of the antenna 110 during the lifetime of the NFC tag 102), manufacturing parameters of an end product (e.g., variation of conductive material properties and design of the antenna 110 during assembly of the NFC tag 102), changing of environmental conditions (e.g., temperature and humidity), and external field effects (e.g., placing a magnetic or electric component near the NFC tag 102 or NFC reader 104). In various embodiment, the changing of the operation frequency is known as a detuning of the antenna 110. The detuning of the antenna 110 can be compensated during a calibration process of the NFC tag 102. The calibration process may include adjusting elements of an equivalent resonance circuit of the IC 108.

In this embodiment, the IC 108 includes an equivalent capacitor 118 (C_{CHIP}) coupled in parallel to the equivalent resonance circuit of the antenna 110 between two nodes A and B. In addition, the IC 108 includes an equivalent resistor 120 (R_{CHIP}) coupled in parallel to the equivalent capacitor 118. The equivalent resonance circuit of the IC 108 generates an output impedance coupled to the antenna 110. Hence, any detuning of the antenna 110 may be calibrated by adjusting the output impedance of the equivalent resonance circuit of the IC 108. In various embodiments of the present disclosure, a tunable capacitor 122 is coupled in parallel to the equivalent resonance circuit of the IC 108 to calibrate the NFC tag 102 by adjusting the output impedance.

The tunable capacitor 122 is coupled in parallel with the equivalent capacitor 118. Thus, a summation of the tunable capacitor 122 and the equivalent capacitor 118 is coupled to the antenna 110. Consequently, adjusting the tunable capacitor 122 results in tuning the output impedance and the operation frequency of the NFC tag 102. The operation frequency may be detuned during the manufacturing process or operation of the NFC system 100. However, the tunable capacitor 122 provides a degree of freedom to tune the operation frequency that is detuned from the standard frequency band of the NFC systems (i.e. 13.56 MHz).

In some conventional calibration processes, the adjusting of the output impedance of the IC 108 may calibrate the operation frequency of the NFC tag 102 after the manufacturing process. However, the operation frequency of the NFC tag 102 may be detuned during the operation. A calibration process is disclosed herein, which provides an opportunity to calibrate the NFC tag 102 not only after manufacturing and during the assembly process, but also during the operation of the NFC system 100. In various embodiments of the present disclosure, the NFC tag 102 is calibrated dynamically, based on receiving a calibration command from the NFC reader 104 at any time during the operation of the NFC system 100. In this condition, the processor of the IC 108 analyses any command received from the NFC reader 104. When the processor detects a calibration command, the tunable capacitor 122 is adjusted to compensate the detuning of the operation frequency.

FIG. 2 is a flowchart 200 which illustrates activating the NFC tag 102 with the NFC reader 104 described in FIG. 1. At 202, the NFC tag 102 described in FIG. 1 is activated by receiving electrical power. In some embodiments, the NFC tag 102 is a passive tag which includes a rectifier that converts the received electromagnetic waves to electrical power for activating the NFC tag 102. Alternatively, the NFC tag 102 is an active tag which includes an internal power source or semi-passive tag which includes a power supply pin. The internal power source or the power supply pin provides at least a portion of electrical power for activating the NFC tag 102.

At 204, when the NFC tag 102 is activated, the processor of the NFC tag 102 sets a default capacitance value to the tunable capacitor 122 described in FIG. 1. The default capacitance value is stored on the memory (register) of the NFC tag 102 during the manufacturing or assembly process. In some embodiments, the default capacitance value is stored in the memory of the NFC tag 102 during a calibration process after the manufacturing. The default capacitance value is determined during the calibration process or designing the antenna 110 based on the operation frequency of the NFC system 100 and the equivalent resonance circuit of the antenna 110. The operation frequency of the NFC system 100 and the equivalent resonance circuit of the antenna 110 depends on the structural and material properties of the antenna 110. Advantageously, the default capacitance value is tunable after the manufacturing and assembly processes, thanks to utilizing the tunable capacitor 122.

At 206, the processor of the NFC tag 102 analyzes received signals from the NFC reader 104 to extract potential commands. The NFC reader 104 generates a calibration command when is coupled to the NFC tag 102 through the wireless communication link 106, described in FIG. 1. The calibration command may be generated every time that the NFC reader 104 is coupled to the NFC tag 102 after a period of time. In addition, the calibration command may be generated when the NFC reader 104 detects a variation of the environmental conditions (e.g., humidity or temperature) or presence of an external field (e.g., placing a magnetic or electric component near the NFC tag 102 or NFC reader 104). This detection by the NFC reader 104 may be based on comparing a resonance frequency of backscattered waves from the NFC tag 102 with a predetermined frequency (e.g., the standard operation frequency of NFC systems 13.56 MHz). In this condition, the NFC reader 104 detects a deviation between the resonance frequency of the NFC tag 102 and the predetermined frequency, and consequently transmits the calibration command to the NFC tag 102.

At 208, the processor of the NFC tag 102 performs an antenna calibration process due to detection of the calibration command from the received signals. In various embodiments, the antenna calibration process is not interrupting a normal performance of the NFC system 100. In the embodiments of the present disclosure, a dynamic calibration process provides the capability of the antenna calibration while the NFC reader 104 and the NFC tag 102 communicate over the wireless communication link 106. Thus, there is no need to stop the communication between the NFC reader 104 and the NFC tag 102 and interrupt the normal performance of the NFC tag 102 when calibrating the antenna 110.

When the processor of the NFC tag 102 detects there is no calibration command in the received signals, the NFC tag 102 continue a normal performance at 210, without executing the antenna calibration process. The normal performance of the NFC tag 102 may include sending identification data (ID) to the NFC reader 104 in response to receiving activation signals. The identification data (ID) of the NFC tag 102 is a unique data which distinguishes the NFC tag 102 from other NFC tags in proximity of the NFC reader 104 or present in the NFC system 100. The normal performance of the NFC tag 102 ends at 212 and the NFC tag 102 may be deactivated until the next cycle. The next cycle is starting by receiving another activating signal from the NFC reader 104. In various embodiments, the NFC reader 104 may include various types of NFC readers attached to different instruments (e.g., mobile or fixed in a location) based on the application of the NFC system 100.

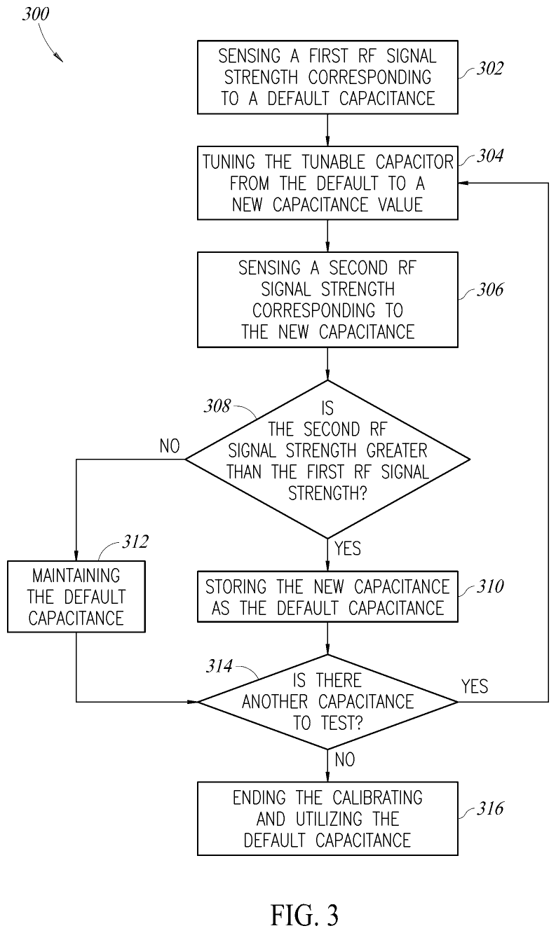

FIG. 3 is a flowchart 300 of calibrating the NFC tag 102 in response to receiving the calibration command from the NFC reader 104 described in FIGS. 1 and 2. In various embodiments, the process of the flowchart 300 is an iterative algorithm stored in the processor or memory of the NFC tag 102 to be executed in response to receiving the calibration command.

At 302, the processor of the NFC tag 102 detects a first signal strength of the received signals by the antenna 110. The first signal strength corresponds to the default capacitance value before changing the tunable capacitor 122. The NFC tag 102 may include a separate detector rather than the processor, which detects the signal strength and sends the result to the processor. In some embodiments, the processor stores the first signal strength in the memory of the NFC tag 102. The signal strength includes an amplitude of the received signal (e.g., a voltage peak of the signal). Alternatively, both amplitude and phase of the received signal are detected and stored in the memory of the NFC tag 102. The received signal may be a radio frequency (RF) signal that is transmitted from the antenna of the NFC reader 104 and is received by the antenna 110.

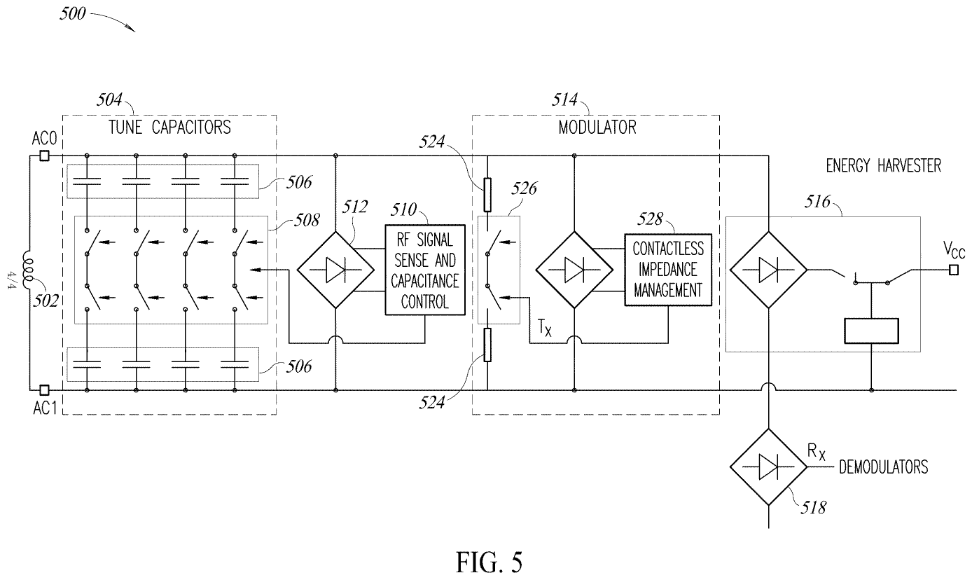

At 304, the processor of the NFC tag 102 changes the capacitance value of the tunable capacitor 122 from the default capacitance value to a new capacitance value. The changing of the capacitance value may include sending a binary code to the tunable capacitor 122. In this condition, the tunable capacitor 122 includes a plurality of capacitors (capacitor bank), which each of the plurality of capacitors is switched ON or OFF based on a bit of data from the binary code. For instance, each of the plurality of capacitors includes a switch that is closed or opened based on the bit of data from the binary code. The switches may be implemented by metal-oxide-semiconductor (MOS) transistors. More details of an example of the circuit implementation are described in FIG. 5.

Alternatively, the changing of the capacitance value includes sending analog signals to the tunable capacitor 122. In this condition, the tunable capacitor 122 includes one or more voltage-controlled capacitors. For instance, a voltage amplitude of the analog signal changes the capacitance values of the one or more voltage-controlled capacitors. In various embodiments, the tunable capacitor 122 may include a combination of both the plurality of capacitors controlled by binary codes and one or more voltage-controlled capacitors.

At 306, the processor of the NFC tag 102 detects a second signal strength of the received signals. The second signal strength corresponds to the new capacitance value which is applied to the tunable capacitor 122 at 304. The processor stores the second signal strength in the memory of the NFC tag 102. As described for the first signal strength at 302, the second signal strength may include the amplitude or a combination of amplitude and phase of the received signal.

At 308, the processor compares the second signal strength with the first signal strength. In some embodiments, the NFC tag 102 may include a separate comparator rather than the processor. For instance, the comparator may be implemented with an operational amplifier (Op-Amp) inside the IC 108 described in FIG. 1. In this condition, an output of the comparator is coupled to the processor.

When the processor detects that the second signal strength is greater than the first signal strength, then the new capacitance value is stored as the default capacitance value in the memory of the NFC tag 102. For instance, the capacitance values may be stored in a table of the memory. In this condition, the table includes a first field which stores the default capacitance value and a second filed which stores the new capacitance value. At 310, the first filed is erased and the new capacitance value of the second field is copied or stored in the first field. Alternatively, the memory stores only one capacitance value as the default capacitance value. In this condition, if the second signal strength is greater than the first signal strength, then the default capacitance value in the memory is replaced with the new capacitance value.

When the processor detects that the second signal strength is not greater than the first signal strength, at 312, the default capacitance value is maintained unchanged in the memory.

The comparison process between the first and second signal strengths determines which of the default capacitance value or the new capacitance value is better matched with the equivalent resonance circuit of the antenna 110 at the operation frequency (e.g., 13.56 MHz). Thus, the process of the antenna calibrations tunes the NFC tag 102 at a desired operation frequency. In some embodiments, the calibration process is performed when the distance and environmental conditions between the NFC reader 104 and the NFC tag 102 remain substantially constant, thus only the changing of the tunable capacitor 122 affects the signal strengths by tuning the output impedance of the IC 108 described in FIG. 1.

After executing the process of either 310 or 312, the processor checks the possible capacitance values of the tunable capacitor 122 at 314. For instance, the tunable capacitor 122 may include a plurality of capacitors, which the number of the plurality of capacitors are stored in the memory of the NFC tag 102. In this condition, the processor determines how many of the plurality of capacitance values are already tested at 304, and if there are other capacitance values that are not tested yet. In response, if there is at least one more available capacitance value that is not tested yet, the calibration process is jumped to 304 to change the capacitance of the tunable capacitor 122 to another new capacitance value and proceed through 304-314.

If the processor indicates that there is not more available capacitance value of the tunable capacitor 122 to be tested, the calibration process ends at 316. At 316, the stored default capacitance value is applied to the tunable capacitor 122 as an output of the calibration process. This default capacitance value remains constant for the IC 108 during the performance of the NFC tag 102, until the NFC tag 102 receives another calibration command from the NFC reader 104. At 316, the processor of the NFC tag 102 may generate a calibration-done signal for transmitting to the NFC reader 104 in response to the calibration command.

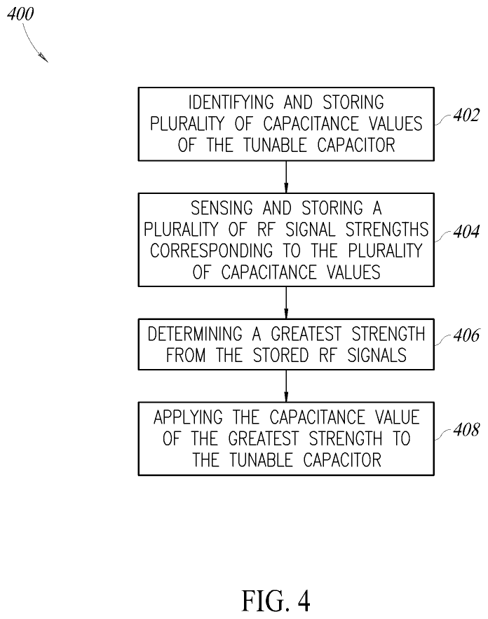

FIG. 4 is a flowchart 400 of an alternative process for calibrating the NFC tag 102 in response to receiving the calibration command from the NFC reader 104 described in FIGS. 1 and 2. The process of the flowchart 400 is different than the iterative algorithm described in FIG. 3. The process of the flowchart 400 is based on an algorithm to find a maximum value from a plurality of values. This algorithm is stored in the processor of the NFC tag 102 to be executed in response to receiving the calibration command.

In some embodiments, both the iterative algorithm of the flowchart 300 and the algorithm of finding a maximum value described in the flowchart 400 may be stored in the processor of the NFC tag 102. In this condition, the processor may select each of the algorithms based on a condition of the calibration. For instance, the NFC reader 104 may send different calibration commands based on the environmental or manufacturing conditions. In some examples, a regular calibration command is generated by the NFC reader 104 after the manufacturing process. In response to the regular calibration command, the processor of the NFC tag 102 selects an algorithm which is faster and has lower accuracy (e.g., the algorithm of the flowchart 400).

While, during the performance of the NFC tag 102, a fine calibration command may be generated by the NFC reader 104 which requests a finer calibration of the NFC tag 102. In response to the fine calibration command, the processor of the NFC tag 102 selects an algorithm which has higher accuracy (e.g., the iterative algorithm of the flowchart 300).

In the calibration process of the flowchart 400, at 402, the processor of the NFC tag 102 identifies a plurality of the capacitance values of the tunable capacitor 122. The plurality of the capacitance values may be stored in the memory of the NFC tag 102 (e.g., in a first column of a table). The processor of the NFC tag 102 changes the capacitance value of the tunable capacitor 122 to the plurality of capacitance values stored in the memory of the NFC tag 102. In response, at 404, the processor of the NFC tag 102 detects a plurality of signal strengths corresponding to the plurality of capacitance values of the tunable capacitor 122. The processor sets each of the plurality of the capacitance values to the tunable capacitor 122 (e.g., from the first column of the table) and detects the corresponding signal strength of capacitance value. In addition, the processor stores the plurality of the signal strengths in the memory of the NFC tag 102 (e.g., in a second column of a table). In some embodiments, a table is stored in the memory of the NFC tag 102 which includes the plurality of the capacitance values in the first column and the plurality of the signal strengths in the second column, where each field of the first column corresponds to a respective field of the second column.

At 406, the processor determines a greatest signal strength between the stored plurality of signal strengths and the respective capacitance value from the stored plurality of capacitance values. The processor may compare each of the plurality of signal strengths with one another and continue the comparison for all the stored plurality of signal strengths until finding the greatest signal strength. Alternatively, the processor may execute a predetermined algorithm to find a maximum value from a list of stored values, such as the stored plurality of signal strengths.

At 408, the processor applies the capacitance value respective to the greatest signal strength to the tunable capacitor 122. This capacitance value remains constant for the IC 108 during the performance of the NFC tag 102, until the NFC tag 102 receives another calibration command from the NFC reader 104. The calibration process of the flowchart 400 may be faster than the iterative process described in the flowchart 300 of FIG. 3. However, due to storing all the data of the plurality of signal strengths and the plurality of the capacitance values in the memory, the process of the flowchart 400 may occupy more space of the memory rather than the process of the flowchart 300.

FIG. 5 is a circuit 500 of an embodiment of the NFC tag 102 described in FIG. 1. In this embodiment, an antenna is represented by a coil 502. A tunable capacitor 504 is coupled in parallel to the coil 502 (between two nodes AC0 and AC1). The tunable capacitor 504 corresponds to and is an example of the tunable capacitor 122 described in FIG. 1. The tunable capacitor 504 includes a plurality of capacitors 506. Each of the plurality of capacitors 506 is configured to be coupled to one switch from a plurality of switches 508. In various embodiments, each switch of the plurality of switches 508 couples one of the plurality of capacitors 506 to the ground. In this condition, an equivalent capacitance value of the tunable capacitor 504 is tunable by controlling the plurality of switches 508. For instance, a subset of the plurality of the switches 508 are closed and a respective subset of the plurality of capacitors 506 are coupled together in parallel. As a result, the equivalent capacitance value of the tunable capacitor 504 is a summation of the subset of the plurality of the capacitors 506.

The circuit 500 includes a control unit 510 which detects the signal strength (as described in FIGS. 3 and 4) and adjusts the tunable capacitor 504 by controlling the plurality of switches 508. In this embodiment, a comparator 512 is coupled to the control unit 510, which compares different signal strengths (e.g., the first and second signal strengths described in FIG. 3). The control unit 510 generates a binary code based on an output of the comparator 512. The binary code controls the plurality of switches 508 to close a subset of the switches and generate a desired equivalent capacitance value. In various embodiments, the plurality of switches 508 may be implemented by N-type MOS transistors. In this condition, a “1” bit of the binary code applied to one of the plurality of switches 508 closes that respective switch, while a “0” bit of the binary code applied to one of the plurality of switches 508 opens that respective switch.

The circuit 500 includes a load modulator 514 which modulates an output load coupled to the IC 108 described in FIG. 1. The load modulator 514 manages the output load of the IC 108 by coupling one or more loads 524 to the coil 502 through load switches 526. In some embodiments, the load modulator 514 includes an impedance control unit 528 which controls the load switches 526 of the one or more loads 524. The impedance control unit 528 may add or reduce the loads coupled to the coil 502 by closing or opening the load switches 526. The control signal to the load switches 526 may be generated based on the identification data (ID) of the NFC tag 102 to be backscattered to the NFC reader 104.

The circuit 500 includes a rectifier circuit 516 (energy harvester) that converts at least a portion of the received electromagnetic waves to electrical power for activating the NFC tag 102. In various embodiments, the rectifier circuit 516 includes diodes (e.g., in bridge combination) and a Zener diode which provides a constant voltage (e.g., Vcc). In addition, the circuit 500 includes a demodulator 518 which demodulates received signals from the NFC reader 104.

A method may be summarized as including receiving a signal by a near-field communication (NFC) tag, the NFC tag including an antenna coupled to a circuit, the circuit including a tunable capacitor; initializing a first capacitance value of the tunable capacitor, the first capacitance value being stored in a memory of the NFC tag; receiving, by the NFC tag, a calibration command; sensing a first strength of the signal with the tunable capacitor having the first capacitance, in response to the calibration command; changing the tunable capacitor to a second capacitance value; sensing a second strength of the signal with the tunable capacitor having the second capacitance value; storing the second capacitance value in the memory in response to the second strength being greater than the first strength.

The method may include activating the NFC tag by rectifying electrical power from the signal.

The receiving the signal and the calibration command may include wirelessly receiving a first and a second signals, respectively.

The method may include activating the NFC tag by receiving electrical power from a power source of the NFC tag.

The receiving the calibration command may include receiving the calibration command through a contact interface.

The changing the tunable capacitor to a second capacitance value may include coupling first ones of a plurality of capacitors to the circuit.

The method may include changing the tunable capacitor to a third capacitance value; sensing a third strength of the signal with the tunable capacitor having the third capacitance; storing the third capacitance value in the memory in response to the third strength being greater than the second strength.

The method may include maintaining the first capacitance value in the memory in response to the second strength being less than the first strength.

The method may include calibrating the NFC tag by applying a stored capacitance value in the memory to the tunable capacitor, the stored capacitance value is one of the first or second capacitance values.

A near-field communication (NFC) system may be summarized as including an antenna; a circuit having an adjustable capacitor coupled to the antenna; and a controller coupled to the circuit configured to tune the adjustable capacitor to a capacitance value of a plurality of capacitance values; sense a plurality of strengths, each of the plurality if strengths corresponds to the current capacitance value of the plurality of capacitance values; determine a greatest strength of the plurality of strengths; and apply the capacitance value of the greatest strength to the adjustable capacitor.

The NFC system may include an NFC tag, and the controller may be configured to calibrate an output impedance of the circuit.

The controller may be configured to start to calibrate the output impedance of the circuit in response to receive a calibration command signal.

The controller may be configured to dynamically calibrate the output impedance of the circuit based on the environmental condition.

The NFC tag may include passive tag that includes a rectifier circuit, the rectifier circuit is configured to generate an electrical power based on the radio frequency signal.

The adjustable capacitor may include a plurality of capacitors coupled to the circuit, each of the plurality of capacitors having a switch.

The controller may be configured to tune the adjustable capacitor by switching ON or OFF the switch of each of the plurality of capacitors.

A method may be summarized as including calibrating an antenna of a near-field communication (NFC) tag, the calibrating including: initializing a capacitance of an adjustable capacitor to a first value from a register of the NFC tag; identifying a maximum value of a radio frequency signal by: sensing a current radio frequency signal of the NFC tag; adjusting the capacitance to a new value of a plurality of second values; sensing a new radio frequency signal of the NFC tag; storing the new value in the register in response to the new radio frequency signal being greater than the current radio frequency signal; and continuing the adjusting the capacitance to the new value, sensing the new radio frequency signal, and storing the new value through all of the plurality of second values.

The calibrating may be in response to receiving a calibration command signal.

The adjusting the capacitance may include switching ON or OFF switches of a plurality of capacitors of the adjustable capacitor.

The method may include applying a capacitance value corresponding to the maximum value of a radio frequency signal to the adjustable capacitor; and generating a calibration-done signal in response to applying the capacitance value.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving a signal by a near-field communication (NFC) tag, the NFC tag including an antenna coupled to a circuit, the circuit including a tunable capacitor;
initializing a first capacitance value of the tunable capacitor, the first capacitance value being stored in a memory of the NFC tag;
receiving, by the NFC tag, a calibration command;
sensing a first strength of the signal with the tunable capacitor having the first capacitance, in response to the calibration command;
changing the tunable capacitor to a second capacitance value;
sensing a second strength of the signal with the tunable capacitor having the second capacitance value;
storing the second capacitance value in the memory in response to the second strength being greater than the first strength.

2. The method of claim 1, comprising activating the NFC tag by rectifying electrical power from the signal.

3. The method of claim 1, wherein the receiving the signal and the calibration command includes wirelessly receiving a first and a second signals, respectively.

4. The method of claim 1, comprising activating the NFC tag by receiving electrical power from a power source of the NFC tag.

5. The method of claim 1, wherein receiving the calibration command includes receiving the calibration command through a contact interface.

6. The method of claim 1, wherein the changing the tunable capacitor to a second capacitance value includes coupling first ones of a plurality of capacitors to the circuit.

7. The method of claim 1, comprising:
changing the tunable capacitor to a third capacitance value;
sensing a third strength of the signal with the tunable capacitor having the third capacitance;
storing the third capacitance value in the memory in response to the third strength being greater than the second strength.

8. The method of claim 1, comprising:
maintaining the first capacitance value in the memory in response to the second strength being less than the first strength.

9. The method of claim 8, comprising:
calibrating the NFC tag by applying a stored capacitance value in the memory to the tunable capacitor, the stored capacitance value is one of the first or second capacitance values.

10. A near-field communication (NFC) system, comprising:
an antenna;
a circuit having an adjustable capacitor coupled to the antenna; and
a controller coupled to the circuit, the controller is configured to:
tune the adjustable capacitor to a capacitance value of a plurality of capacitance values;
sense a plurality of strengths, each of the plurality if strengths corresponds to the current capacitance value of the plurality of capacitance values;
determine a greatest strength of the plurality of strengths; and
apply the capacitance value of the greatest strength to the adjustable capacitor.

11. The system of claim 10, wherein the NFC system is an NFC tag, and the controller is configured to calibrate an output impedance of the circuit.

12. The system of claim 11, wherein the controller starts to calibrate the output impedance of the circuit in response to receive a calibration command signal.

13. The system of claim 12, wherein the controller is configured to dynamically calibrate the output impedance of the circuit based on the environmental condition.

14. The system of claim 11, wherein the NFC tag is passive tag that includes a rectifier circuit, the rectifier circuit is configured to generate an electrical power based on the radio frequency signal.

15. The system of claim 10, wherein the adjustable capacitor includes a plurality of capacitors coupled to the circuit, each of the plurality of capacitors having a switch.

16. The system of claim 15, wherein the controller is configured to tune the adjustable capacitor by switching ON or OFF the switch of each of the plurality of capacitors.

17. A method, comprising:
calibrating an antenna of a near-field communication (NFC) tag, the calibrating including:
initializing a capacitance of an adjustable capacitor to a first value from a register of the NFC tag;
identifying a maximum value of a radio frequency signal by:
sensing a current radio frequency signal of the NFC tag;
adjusting the capacitance to a new value of a plurality of second values;
sensing a new radio frequency signal of the NFC tag;
storing the new value in the register in response to the new radio frequency signal being greater than the current radio frequency signal; and
continuing the adjusting the capacitance to the new value, sensing the new radio frequency signal, and storing the new value through all of the plurality of second values.

18. The method of claim 17, wherein the calibrating is in response to receiving a calibration command signal.

19. The method of claim 17, wherein adjusting the capacitance includes switching ON or OFF switches of a plurality of capacitors of the adjustable capacitor.

20. The method of claim 17, comprising:
applying a capacitance value corresponding to the maximum value of a radio frequency signal to the adjustable capacitor; and
generating a calibration-done signal in response to applying the capacitance value.
